(19) United States
(12) Patent Application Publication
(10) Pub. No.: US 2014/0269281 A1
(43) Pub. Date: Sep. 18, 2014

(54) Apparatus and Method for Providing Sort Offload

(71) Applicants: Muhammad Raghib Hussain, Saratoga, CA (US); Vishal Murgai, Cupertino, CA (US)

(72) Inventors: Muhammad Raghib Hussain, Saratoga, CA (US); Vishal Murgai, Cupertino, CA (US)

(73) Assignee: Cavium, Inc., San Jose, CA (US)

(21) Appl. No.: 14/072,776

(22) Filed: Nov. 5, 2013

Related U.S. Application Data
(63) Continuation-in-part of application No. 13/830,395, filed on Mar. 14, 2013.

(51) Int. Cl. H04L 12/851; H04W 28/02

(52) U.S. Cl. CPC H04L 47/2441; H04W 28/0289; H04L 47/2433
USPC 370/230

(57) ABSTRACT

An apparatus includes a core processor and a hardware based sort coprocessor. In one embodiment, the core processor is able to generate an input array. The hardware based sort coprocessor is configured to sort the input array in accordance with a metric and flag of each element to be sorted in the input array and generate a sorted array.

### PRIORITY

This patent application is a continuation-in-part (CIP) continuation of U.S. patent application Ser. No. 13/830,395, filed Mar. 14, 2013, entitled Apparatus and Method for Media Access Control Scheduling with a Sort Hardware Coprocessor, the disclosure of which is incorporated herein by reference.

### FIELD OF THE INVENTION

This invention relates generally to mobile wireless communication systems. More particularly, this invention relates to a mobile wireless communication node utilizing a sort processor.

### BACKGROUND OF THE INVENTION

A mobile wireless communication system processes packet data to satisfy specified quality of service parameters. The quality of service parameters may include bit error rate, packet latency, service response time, packet loss rate, signal-to-noise ratio and the like. Prioritizing packet transfers is a complex and critical task. Accordingly, there is a need to improve existing techniques for prioritizing traffic in mobile wireless communication systems.

### SUMMARY OF THE INVENTION

An apparatus includes a core processor and a hardware based sort coprocessor. In one embodiment, the core processor is able to generate an input array. The hardware based sort coprocessor is configured to sort the input array in accordance with a metric and flag of each element to be sorted in the input array and generate a sorted array.

In one embodiment, a method or process is illustrated in accordance with the sorting process of various individual elements. The process or method is capable of identifying a header element and writing the identified header element to an input array by a core processor. After sorting an individual element associated with the identified header element in response to a metric indicator stored in the identified header element, the sorted elements are stored in an output array.

### BRIEF DESCRIPTION OF THE FIGURES

The invention is more fully appreciated in connection with the following detailed description taken in conjunction with the accompanying drawings, in which:

FIG. 1 illustrates a system configured in accordance with an embodiment of the invention.

FIG. 2 illustrates a node configured in accordance with an embodiment of the invention.

FIG. 3 illustrates processing operations performed in accordance with an embodiment of the invention.

FIG. 4 illustrates a system configured to perform sort processing operations in accordance with an embodiment of the invention.

Like reference numerals refer to corresponding parts throughout the several views of the drawings.

### DETAILED DESCRIPTION OF THE INVENTION

FIG. 1 illustrates a system 100 configured in accordance with an embodiment of the invention. The system 100 includes network elements 102, which coordinate communications for a set of network nodes 104_1 through 104_N. By way of example, the network elements 102 may include Mobility Management Entities (MMEs), Serving Gateways (S-GWs), Packet Data Network Gateways (P-GWs) and the like. The network node 104 may be hardware that is connected to a mobile phone network to communicate directly with user equipment 110_1 through 110_N (e.g., mobile handsets).

The network node 104 may be an Evolved Node B (also referred to as eNB, eNodeB or E-UTRAN Node B). Evolved Node B is the element in the Evolved Universal Terrestrial Radio Access (E-UTRA) of Long Term Evolution (LTE) that is the evolution of the element Node B in Universal Terrestrial Radio Access (UTRA) of the Universal Mobile Telecommunications System (UMTS). Evolved Node B is the hardware that is connected to the mobile phone network that communicates directly with mobile handsets (e.g., UEs 110), like a base transceiver station (BTS) in GSM networks. Traditionally, a Node B has minimum functionality, and is controlled by a Radio Network Controller (RNC). However, with an eNodeB, there is no separate controller element. This simplifies the architecture and allows lower response times.

Node 104 includes Layer-2 and Layer-3 functional blocks 106. These blocks may include Packet Data Convergence Protocol (PDCP) blocks, Radio Link Control (RLC) blocks, MAC blocks and the like. Functional blocks 106 communicate with Layer-1 blocks 108_1 through 108_N. The Layer-1 blocks are Layer-1 physical layer functional blocks that communicate with the user equipment (e.g., mobile devices) 110_1 through 110_N. The Layer-1 blocks establish a duplex communication path (e.g., frequency division duplex communications or time division duplex communications) with user equipment. The communication path is a packet channel, where each packet may have speech, data, picture or video information.

FIG. 2 is a more detailed characterization of a node 104 configured in accordance with an embodiment of the invention. The node includes a number of queues 200_1 through 200_N for storing packet communications. The queues 200 reside above or at the media access layer (e.g., network layer, transport layer).

The media access layer includes MAC schedulers 202_1 through 202_N. Each MAC scheduler 202 is a software process or thread executing on a processor. Shared memories 204_1 through 204_N and sort coprocessors 206_1 through 206_N also reside at the MAC layer.

Each MAC scheduler 202 generates requests for user data sorted by priority. In one embodiment, a sort request is written to shared memory 204. The sort coprocessor 206 notes the write operation and initiates operations to generate a sorted array. More particularly, the sort coprocessor services the user sort request in accordance with specified user processing priority parameters to generate a sorted array. The MAC scheduler 202 retrieves the sorted array, loads it into a media access control block and applies the block to one of the downlink channels 210_1 through 210_N or uplink channels 208_1 through 208_N of the physical layer.

FIG. 3 illustrates processing operations associated with an embodiment of the invention. In particular, the figure illustrates interactions between the MAC scheduler 202, shared memory 204 and sort coprocessor 206. In one embodiment, the scheduler processor 202 writes a request 300 to shared memory 204, which stores the request 302. In one embodiment, the write request specifies an address in a queue 200, a number of entries to assess in the queue, and a number of sorted elements to return.

The sort coprocessor 206 accesses the request 304, processes the request 306 and writes results 308. The sort coprocessor is a hardware resource that processes each request in accordance with user processing priority parameters. The sort coprocessor is configured to prioritize traffic based upon a priority parameter, which is computed based on several quality of service parameters (e.g., bit error rate, packet latency, service response time, packet loss, signal-to-noise ratio, etc.), channel conditions, wait-in-queue time, timing efficiency and the like.

The shared memory 204 stores the sorted results 310. The MAC scheduler 202 accesses the results 312 and processes the results 314. The sort coprocessor 206 may use a zero byte write to a specified location in shared memory 204 or use an interrupt to advise the MAC scheduler 202 of available results. Processing of the results may include loading the results into a media access control block that is assigned to a downlink channel 210. Control then returns to block 300.

The operations of the invention have been fully disclosed. The following disclosure relates to specific implementation details that may be utilized in accordance with certain embodiments of the invention. Each MAC scheduler 202 allocates down link and up link radio resources to each mobile device based upon quality of service requirements. The priority of each user device may be a function of time (e.g., the longer it waits in a queue 200 the higher its priority for the next scheduling iteration). For a given quality of service level, the MAC scheduler 202 searches the list of user devices waiting for air resources and tries to find the best suitable candidates for allocation of radio resources. Thus, sorting and selecting operations are repeatedly performed (e.g., every 1 msec). Candidates are selected based upon priority, which may be a weighted average of several constantly changing metrics (e.g., quality of service, channel conditions, wait-in-queue, etc.).

The foregoing operations may be implemented using an application program interface. The following documented code is an example of an application program interface that may be used in accordance with an embodiment of the invention.

typedef octeon_sort_t; /*Octeon refers to a processor sold by Cavium

```
Networks, Inc.*/
{
  uint8_t key[4];
  uint8_t context_pointer[8];
} OCTEON_SORT_T;
typedef octeon_sort_instruction_t
```

{

| | |
|---|---|
| Uint8 data_type; | /* float or integer */ |
| Uint8 sort_type; | /* ascending or descending order */ |
| Uint8 response_type | /* specifies how coprocessor should notify scheduler about |

completion, e.g., interrupt or zero-byte write */

| | |
|---|---|
| uint32 address; | /* pointer or address to do zero-byte write */ |

uint32 response_address; /* starting address location where SORT unit would write

results to */
} OCTEON_SORT_INSTRUCTION_T;
int octeon_sort_submit (

| OCTEON_SORT_T *octeon_sort_input_array, | |
|---|---|
| int | numOfUsers, |
| int | maxNumUsersToSelect, |

OCTEON_SORT_INSTRUCTION_T *octeon_sort_params);

| | |
|---|---|
| octeon_sort_input_array: | /*pointer to input OCTEON_SORT_T list*/ |
| numOfUsers: | /*number of input elements to sort*/ |
| maxNumUsersToSelect: | /*number of output selected and sorted elements*/ |
| Octeon_sort_params: | /*various parameters for control, input and |

output info needed by SORT engine*/

Thus, various parameters may be used to control the sort operations. In the foregoing example, data type is specified (i.e., floating point or integer), sort order (i.e., ascending or descending) is specified and response parameters are specified (i.e., response type and memory address information). The foregoing code also specifies a number of entries to consider and a number of entries to return. The last line of code indicates that sort parameters may be passed to the coprocessor 206. Thus, the coprocessor 206 may utilize specified user priority parameters that are pre-existing and/or passed to the coprocessor 206 in connection with a request for sorted results.

Those skilled in the art will appreciate that media access control scheduling is a critical function performed by base stations. The sort coprocessor 206 helps improve MAC scheduler performance. This facilitates the utilization of a lower number of processor (cores) required for MAC scheduler operation.

FIG. 4 illustrates a system configured to perform sort processing operations in accordance with an embodiment of the invention. In particular, the figure illustrates interactions between core processors 402-1 through 402_N, shared memory 404_1 through 404_N, sort coprocessors 406_1 through 406_N, input array structures 408_1 to 408_N, and array output structures 410_1 through 410_N.

Shared memory 404 may be implemented with L2/DDR memory or any memory known by a person having ordinary skill in the art as having performance characteristics like L2/Double Data Rate (DDR) memory or better for a given sort application.

A core processor 402 writes a header element 412 to an input array 408, the header element comprising a metric indicator 414. Other fields may be within the header element 412. The input array to be sorted may be a fixed size such as 4 k bytes or may be a dynamic size, wherein the header element 412 indicates the size of an input array to sort. In an embodiment, header elements may be stacked at the front of the input array 408 to allow for parallel processing of the input array 408, wherein each header element corresponds to an input array to be sorted from a plurality of input arrays within the input array 408. Thus, the input array 408 is comprised of a plurality of header elements at the front part of the input array 408 followed by their corresponding plurality of input arrays to be sorted.

Core processor 402 writes elements to the input array 408, which may later be sorted by a sort coprocessor 406 provided that a flag 416 for an individual element is set to indicate that the element is to be sorted. Only those elements in the input array 408 that have their flag 416 set to sort, does the element get sorted by the sort coprocessor 406. The flag 416 may be located in any portion of an individual element.

The flag 416 can be implemented as a separate bit or as part of an encoded bit within a number of bits such that the flag can later be decoded by a sort coprocessor 406. The metric indicator 414 indicates the metric that the sort coprocessor 406 will use to sort elements of the input array 408. In an embodiment, the metric indicator 414 may be an encoded metric indicator. In another embodiment, the metric indicator 414 may be an index into an array of metric indicators. In yet another embodiment, the metric indicator 414 may be an index into a first array of any number of indirect arrays, wherein the final metric indicator indicates the metric to be used by the sort coprocessor 406 to sort the input array 408.

The input array 408 is written to by a core processor 402 into shared memory 404. The input array 408 is read from the shared memory 404 by the sort coprocessor 406. The sort coprocessor 406 sorts only those elements of the input array 408, which have their flags set to sort; otherwise, the sort coprocessor 406 ignores elements of the input array 408 that do not have their flags set to sort. The remaining elements of the input array are the elements with their flags set to sort. The sort coprocessor 406 sorts the remaining elements of the input array 408 according to the metric indicator 414 and places sorted elements into the output array 410. The sorted output array is then returned back to the core processor 402. The return function can be executed by any method known to a person having ordinary skill in the art.

In an embodiment, the output array 410 is also within shared memory 404. In another embodiment, the output array 410 is implemented in another hardware element such as a set of registers. Any number of methods known to a person having ordinary skills in the art may be used to store and access the output array 410.

In an embodiment, the core processors 402 are the same as the MAC schedulers 202, the shared memory 404 is the same as the shared memory 204, and the sort coprocessor 406 is the same as the sort coprocessor 206. In another embodiment, the core processors 402, shared memory 404, and sort coprocessor 406 are hardware elements separate from MAC schedulers 202, shared memory 204, and sort coprocessors 406, respectively, thereby enabling another separate set of sorting functions to be executed in parallel.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. An apparatus, comprising:
a core processor able to generate an input array; and
a hardware based sort coprocessor configured to sort the input array in accordance with a metric and flag of each element to be sorted in the input array and generate a sorted array.

2. The apparatus of claim 1, further comprising a shared memory configured to store at least one metric and one flag for facilitating sorting.

3. The apparatus of claim 2, further comprising an input array structure configured to store at least a portion of the elements which are flagged to be sorted.

4. The apparatus of claim 3, further comprising an output array configured to hold sorted elements processed by the hardware based sort coprocessor.

5. The apparatus of claim 1, wherein the shared memory includes L2 DDR memory.

6. The apparatus of claim 1, wherein the core processor writes a sort request to a memory and the sort coprocessor reads the sort request from the memory.

7. A base station capable of sort offloading packet traffic comprising the apparatus of claim 1.

8. A method of sorting packet stream, comprising:
identifying a header element and writing the identified header element to an input array by a core processor;
sorting an individual element associated with the identified header element in response to a metric indicator stored in the identified header element; and
storing sorted elements in an output array.

9. The method of claim 8, wherein sorting the individual element includes decoding encoded metric indicator.

10. The method of claim 8, wherein sorting the individual element includes identifying an index of indirect array.

11. The method of claim 8, wherein sorting an individual element includes rearranging a plurality of elements in response to their flags.

12. The method of claim 11, wherein sorting an individual element includes ignoring elements in the input array if their sort flags are in reset.
